(19) United States
(12) Patent Application Publication
(10) Pub. No.: US 2026/0030429 A1
(43) Pub. Date: Jan. 29, 2026

(54) CHIPLET DESIGN OPTIMIZATION

(71) Applicant: INTERNATIONAL BUSINESS MACHINES CORPORATION, Armonk, NY (US)

(72) Inventors: RYO FUJII, Midori-ku (JP); Masaharu Sakamoto, Yokohama (JP); Yoshifumi Sakamoto, Konan-shi (JP); Kenji Konishi, Chofu-shi (JP); KENTARO AOTA, Kitanagoya-city (JP); Katsutoshi Kojima, Toshima-ku (JP); Kazuto Yamafuji, Yokohama (JP)

(21) Appl. No.: 18/782,593

(22) Filed: Jul. 24, 2024

(51) Int. Cl. G06F 30/398; G06F 119/06; G06F 119/08

(52) U.S. Cl. CPC G06F 30/398; G06F 2119/06; G06F 2119/08

(57) ABSTRACT

Layout methods and systems include determining an inter-chiplet communication model for chiplets of a semiconductor device design. A layout of the chiplets is optimized using an objective function that is a weighted combination of different objectives. A semiconductor device is fabricated in accordance with the layout of the chiplets by mounting the chiplets to a base substrate.

### BACKGROUND

The present invention generally relates to semiconductor device fabrication and, more particularly, to semiconductor devices based on chiplets.

Electronic devices may be fabricated using chiplets, which may be understood as a set of chips that are integrated into a single device by mounting them on a shared base. The chiplets may be designed with different respective functions, and may further be manufactured according to different manufacturing processes, potentially by different sources. The component chiplets of the combined device can thereby be selected to provide optimal cost effectiveness and efficiency.

However, the use of chiplets necessitates managing communication between the different chiplets. These communications incur a cost in increased energy consumption.

### SUMMARY

A layout method includes determining an inter-chiplet communication model for chiplets of a semiconductor device design. A layout of the chiplets is optimized using an objective function that is a weighted combination of different objectives. A semiconductor device is fabricated in accordance with the layout of the chiplets by mounting the chiplets to a base substrate.

A computer program product for layout includes a set of one or more computer readable storage media and program instructions, collectively stored in the set of one or more storage media, for causing a processor set to perform computer operations, including to determine an inter-chiplet communication model for chiplets of a semiconductor device design, to optimize a layout of the chiplets using an objective function that is a weighted combination of different objectives, and to fabricate a semiconductor device in accordance with the layout of the chiplets by mounting the plurality of chiplets to a base substrate.

A computer system for layout includes a processor set, a set of one or more computer readable storage media, and program instructions, collectively stored in the set of one or more storage media, for causing a processor set to perform computer operations, including to determine an inter-chiplet communication model for chiplets of a semiconductor device design, to optimize a layout of the chiplets using an objective function that is a weighted combination of different objectives, and to fabricate a semiconductor device in accordance with the layout of the chiplets by mounting the plurality of chiplets to a base substrate.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a semiconductor device that includes multiple chiplets, in accordance with an embodiment of the present invention;

FIG. 2 is a block/flow diagram of a chiplet layout optimization method that accounts for multiple different optimization objectives, in accordance with an embodiment of the present invention;

FIG. 3 is a diagram of chiplets mounted to a base substrate, in accordance with an embodiment of the present invention; and

FIG. 4 is a block diagram of a computing environment that can perform chiplet layout optimization, in accordance with an embodiment of the present invention.

### DETAILED DESCRIPTION

When chiplets are used to create a semiconductor device, inter-chiplet communications consume energy and thereby decrease the energy efficiency of the device as a whole. To address this, a network-on-a-chip interface may be used to manage inter-chiplet communications. In addition, the placement of the chiplets on a base substrate may be optimized to minimize energy consumption from, e.g., resistive losses.

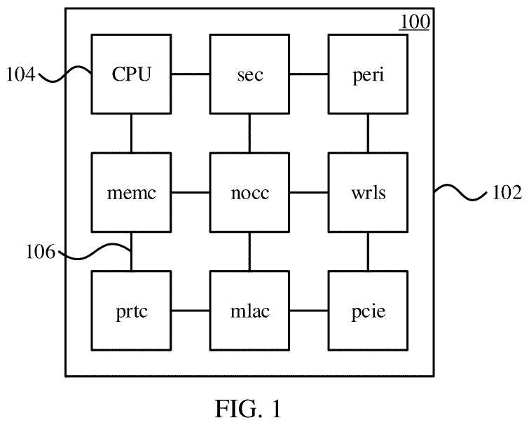

Referring now to FIG. 1, a top-down view of a semiconductor device 100 is shown. The semiconductor device 100 includes a base substrate 102 and chiplets 104. The chiplets 104 may be mounted to the base substrate using any appropriate electromechanical mechanism, such as solder balls, and may communicate with one another via interconnects 106 in the base substrate 102.

During design of the semiconductor device 100, the chiplets 104 and the interconnects 106 may be placed to minimize energy consumption. This optimization process considers the distance between chiplets 104 and the wiring length of chiplet-to-chiplet interconnects 106, and the choice of technology nodes for each chip in the chiplet. In choosing the technology node, cost considerations such as chip development and manufacturing costs may be taken into account. For example, technology nodes that employ smaller-scale feature sizes can reduce heat generation, but this may come at a higher manufacturing cost.

In this example, a variety of different chiplets 104 are shown having different respective functions. For example, the chiplets 104 may include a central processing unit (CPU), security subsystem (sec), input/output peripherals (peri), memory controller (memc), network-on-a-chip interface controller (nocc), wireless subsystem (wrls), network protocol transfer (prtc), machine learning accelerator (mlac), and/or high-speed wired peripheral (pcie) chiplets. The interconnects 106 may directly connect respective chiplets 104 and/or may make indirect connections between chiplets 104. It should be understood that the number and particular function of the chiplets 104 as shown are selected for illustrative purposes only and should not be considered limiting. Each interconnect may have a respective bandwidth, for example being measured in bits per second.

To that end, chiplet models and inter-chiplet communication models may be used. For example, the designer of a chiplet 104 may determine use cases and applications for the chiplet 104 as designed values, while past measurements relating to the chiplet's performance may be stored in a database as measured values. Based on these models, chiplet placement on the base substrate 102 may be optimized to reduce the energy needed for inter-chiplet communication. Other optimization goals may similarly be achieved, such as distribution of heat across the base substrate 102 and the minimization of total cost of the semiconductor device 100. For example, arranging chiplets 104 close together can reduce energy consumption by reducing the resistance of the interconnects 106, but this can make it difficult to adequately dissipate heat generated by the chiplets 104.

The chiplet model may be based on specifications for the chiplets. Past design data for chiplets may be identified that meet the specifications for the chiplets, with exemplary specifications including chiplet size, chiplet energy consumption (based on the technology node and operation of the chiplet), and chiplet cost.

The inter-chiplet communication model may be created by modeling inter-chip bus usage bandwidth for different operating states, based on the amount of data being transferred on the bus. Modeling may include information taken from the designer relating to the use case of a chiplet 104 and past measurements from chiplets. Stored chiplet designs may be reused when they match the needs of a given design.

The models may be used to optimize chiplet layout on the base substrate 102, thereby providing a design that minimizes energy use with only parameters from early stages of the design of the semiconductor device 100. Before the design of the semiconductor device 100 is finalized, only existing data can be optimally positioned, for example based on chiplet specifications and inter-chip communication specifications. This provides flexibility in design and technology node selection. By modeling chiplet specifications and inter-chiplet communication separately, loosely coupled with input/output (I/O) and eliminating dependencies, new chiplet specifications and communication specifications can provide an optimal solution without modifying other models.

To arrange N chiplets 104 on a substrate of size H×W, with H representing a height in a y axis and with W representing a width in an x axis, decision variables may include the position of each chiplet 104, a rotation or orientation of each chiplet 104, and the size of each chiplet 104 based on the technology node used to fabricate it. The decision variables may therefore include x₀(i) for the x coordinate of the bottom-left corner of chiplet i, y₀(i) for the y coordinate of the bottom-left corner of chiplet i, r(i) for indicating whether the chiplet i is rotated, and n^{12 nm}(i) for indicating a technology node of the chiplet i (e.g., with 0 representing a 7 nm node and with 1 representing a 12 nm node). The chiplets may be identified by the index i, with i=1 . . . . N and with N representing the number of chiplets 104 in a semiconductor device 100. Although the 7 nm and 12 nm technology nodes are specifically contemplated and described herein, it should be understood that any appropriate two or more technology nodes may be used instead.

The model may further include various constants, including Dₘᵢₙ to define a minimum distance between chiplets, w^{k}(i) to define a width of chiplet i having technology node k, h^{k}(i) to define a height of chiplet i, P^{k}(i) to define energy consumption of chiplet i, C(i, j) to define volume of communications between chiplets i and j, e^{k}(i) to define a cost of chip i that may include manufacturing and/or development expenses, and E_{bit} to define energy consumption per unit distance to transmit a predetermined amount of data.

Optimization of the chiplet layout includes determination of decision variable values that minimize or maximize the value of an objective function. The objective function may include communication energy consumption, temperature, and cost. For example, communication energy consumption may be calculated as:

$${η}_{C} = {\sum }_{i = 1}^{N} {\sum }_{j = i}^{N} d ( i , j ) C ( i , j ) {E}_{bit}$$

where d(i, j) is a Manhattan distance metric between the centers of chips i and j given by:

$$d ( i , j ) = \vert {x}_{c} ( i ) - {x}_{c} ( j ) \vert + \vert {y}_{c} ( i ) - {y}_{c} ( j ) \vert$$

where x_{c}(i), y_{c}(i), x₁(i), and y₁(i) represent the x coordinate of the center, y coordinate of the center, x coordinate of the top-right corner, and y coordinate of the top-right corner of the chiplet i, respectively. These are defined as follows:

$${x}_{c} ( i ) = \frac{( {x}_{1} ( i ) - {x}_{0} ( i ) )}{2}$$

$${y}_{c} ( i ) = \frac{( {y}_{1} ( i ) - {y}_{0} ( i ) )}{2}$$

$${x}_{1} = {x}_{0} ( i ) + {n}^{12 n m} ( r ( i ) {h}^{12 n m} ( i ) + ( 1 - r ( i ) ) {w}^{12 n m} ( i ) ) + ( 1 - {n}^{12 n m} ( i ) ) ( r ( i ) {h}^{7 n m} ( i ) + ( 1 - r ( i ) ) {w}^{7 n m} ( i ) )$$

$${y}_{1} = {y}_{0} ( i ) + {n}^{12 n m} ( r ( i ) {w}^{12 n m} ( i ) + ( 1 - r ( i ) ) {h}^{12 n m} ( i ) ) + ( 1 - {n}^{12 n m} ( i ) ) ( r ( i ) {w}^{7 n m} ( i ) + ( 1 - r ( i ) ) {h}^{7 n m} ( i ) )$$

Communication energy consumption is proportional to the distance between chips and communication volume. As the distance between chips increases and the amount of communication data grows, so too does the communication energy consumption. The communication energy consumption η_{C} may be normalized with respect to other evaluation metrics as follows:

$$norms ( {η}_{C} ) = \frac{{η}_{C} - {η}_{Cmin}}{{η}_{Cmax} - {η}_{Cmin}}$$

$${η}_{Cmax} = {\sum }_{i = 1}^{N} {\sum }_{j = i}^{N} {d}_{max} C ( i , j ) {E}_{bit}$$

$${η}_{Cmin} = {\sum }_{i = 1}^{N} {\sum }_{j = i}^{N} {d}_{min} C ( i , j ) {E}_{bit}$$

$${d}_{max} = {max}_{i , j ∈ N , i \neq j} d ( i , j )$$

$${d}_{min} = {min}_{i , j ∈ N , i \neq j} d ( i , j )$$

Here dₘₐₓ and dₘᵢₙ represent the minimum and maximum Manhattan distances between two chiplets when selecting from N types.

The temperature of the chiplet i be calculated as:

$${η}_{T} = {\sum }_{i = 1}^{N} {\sum }_{j = 1}^{N} \frac{{n}^{12 n m} ( i ) {P}^{12 n m} ( i ) + ( 1 - {n}^{12 n m} ( i ) ) {P}^{7 n m} ( i )}{d ( i , j )}$$

Temperature is proportional to energy consumption and inversely proportional to chiplet spacing. As the energy consumption of the chiplets increases, the generated heat increases. As the distance between chips decreases, the heat sources concentrate in a smaller area, leading to an increase in temperature. The temperature η_{T}(i) may be normalized with other evaluation metrics as:

$$norms ( {η}_{T} ) = \frac{{η}_{T} - {η}_{Tmin}}{{η}_{Tmax} - {η}_{Tmin}}$$

$${η}_{Tmax} = {\sum }_{i = 1}^{N} {\sum }_{j = i}^{N} \frac{{n}^{12 n m} ( i ) {P}^{12 n m} ( i ) + ( 1 - {n}^{12 n m} ( i ) ) {P}^{7 n m} ( i )}{{d}_{max}}$$

$${η}_{Tmin} = {\sum }_{i = 1}^{N} {\sum }_{j = i}^{N} \frac{{n}^{12 n m} ( i ) {P}^{12 n m} ( i ) + ( 1 - {n}^{12 n m} ( i ) ) {P}^{7 n m} ( i )}{{d}_{min}}$$

Cost may be defined as the sum of costs for each chiplet:

$${η}_{E} ( i ) = {\sum }_{i}^{N} {n}^{12 n m} ( i ) {e}^{12 n m} ( i ) + ( 1 - {n}^{12 n m} ( i ) ) {e}^{7 n m} ( i )$$

The cost η_{E} can be normalized with the other metrics as:

$$norms ( {η}_{E} ) = \frac{{η}_{C} - {η}_{Emin}}{{η}_{Emax} - {η}_{Emin}}$$

where η_{Emax} and η_{Emin} represent the maximum and minimum costs when choosing N types of chiplets from two technology node options, such as 12 nm and 7 nm.

A total objective function n may be expressed as a weighted sum of individual objectives, including the communication energy consumption η_{C}, the temperature η_{T}, and the cost η_{E}:

$$min η = α norm s ( {η}_{C} ) + β norm s ( {η}_{T} ) + γ norm s ( {η}_{E} )$$

subject to:

$${x}_{1} ( i ) \leq w$$

$$y ( i ) \leq H$$

$$d ( i , j ) \geq {D}_{min} , ∀ i , j ∈ N$$

where α, β, and γ are weights that satisfy the condition α+β+γ=1.

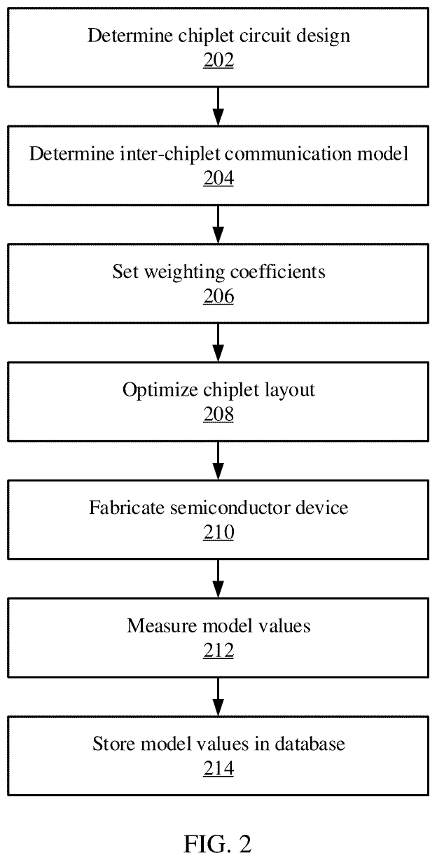

Referring now to FIG. 2, a method for optimizing chiplet placement is shown. Block 202 specifies a chiplet circuit design, for example by identifying functions and specifications for the chiplets that are to be included. For example, block 202 may specify high-level needs for functional and non-functional aspects of the semiconductor device 100, including performance targets, power consumption limits, footprint constraints, and thermal needs. Based on these specifications, block 202 may further identify the chiplets 104 that are needed to implement the semiconductor device 100, for example selecting chiplets 104 that can meet the functional and non-functional specifications.

Block 204 then creates an inter-chiplet communication model, for example using designed values or measured values. The model may include a definition for the bandwidth of the interconnects 106. This may be performed using designed values or measured values. When using designed values, a designer determines the bandwidth of the interconnects 106, energy consumption of each chiplet 104 based on the specifications from block 202, chiplet behavior, and chiplet design specifications provided by the chiplet vendor. When using measured values, the properties of the chiplets 104 may be measured in use, for example from the performance of prior semiconductor devices. Key values, such as bandwidth of interconnects 106 and energy consumption of chiplets 104, may be measured in use and may be stored in a database. Information such as the physical size of the chiplets 104 and their cost may be provided by the chiplets' vendors.

For example, the quantities w^{k}(i), h^{k}(i), and e^{k}(i) may be provided by chiplet vendors. On the other hand, the quantities P^{k}(i) and C(i, j) depend on usage. These values may be derived by operational simulation, based on the design values and assuming the usage, or may be measured values of similar chips that are retrieved from the database. Constraints may be imposed, for example using a boundary constraint to prevent a chiplet 104 from sticking out over the edge of the base substrate 102 or a minimum distance constraint to prevent the distance metric d(i, j) for particular chiplets i and j from falling below a minimum distance Dₘᵢₙ. Other exemplary constraints may include setting maximum values for temperature and energy consumption.

Block 204 sets the weighting coefficients for the different parts of the objective function n. Block 208 optimizes the chiplet layout by minimizing n and thereby determining the decision variables that select chiplets and position them on the base substrate. Based on this chiplet layout, block 210 fabricates a semiconductor device 100 using chiplets 104 and base substrate 102. The optimization may use an objective function that employs any combination of the communication energy consumption, temperature, and cost terms with respective weighting parameters.

Fabrication may include fabricating the chiplets 104 or sourcing them from third-party manufacturers and attaching them to the base substrate in the layout provided by the optimization of block 208. Fabrication 210 may include fabricating the base substrate 108 to include interconnects 106 and any appropriate signal control circuitry, including electrical contacts on a surface of the base substrate 108. Solder may be applied to the electrical contacts and chiplets 104 may be positioned on the solder. A reflow process may be performed to melt the solder, thereby creating solder connections between the base substrate 102 and the chiplets 104. Any further process may be applied, such as applying adhesive, to strengthen the mechanical connection between the base substrate 102 and the chiplets.

The finished semiconductor device 100 may then be tested in block 212, measuring the actual values for quantities such as communications volume and temperature. Block 214 stores these model values in a database, so that they can be used when designing future semiconductor devices. These measured values may be more accurate than the values specified by the designer or vendor.

To provide a specific, non-limiting example, the nine exemplary chiplets 104 of FIG. 1 may be arranged on an exemplary base substrate 102 that is 20 mm by 20 mm in size. The minimum distance between chiplets 104 may be set to be 1 mm, and the chip sizes, energy consumption, and costs may be as defined in Table 1, where the chiplet names are as described above, the size of the chiplet for a given technology node is indicated in the ‘A’ row, the energy consumption of the chiplet for a given technology node is indicated in the ‘E’ row, and the cost of the chiplet for a given technology node is indicated in the ‘$’ row.

TABLE 1

| Chiplet | | memc | nocc | cpu | mlac | prtc | sec | pcie | wrls | peri |
|---|---|---|---|---|---|---|---|---|---|---|
| 12 nm | A | 4.5 × 1.5 | 7.5 × 1.5 | 4.5 × 1.5 | 4.5 × 1.5 | 4.5 × 1.5 | 4.5 × 1.5 | 4.5 × 1.5 | 4.5 × 1.5 | 4.5 × 1.5 |
| node | E | 70 | 50 | 30 | 30 | 10 | 20 | 30 | 20 | 10 |
| | $ | 3.9 | 7.9 | 5.9 | 5.9 | 5.9 | 5.9 | 5.9 | 5.9 | 5.9 |
| 7 nm | A | 3.3 × 1.1 | 5.4×3.3 | 3.3×3.3 | 3.3×3.3 | 3.3 × 3.3 | 3.3×3.3 | 3.3 × 3.3 | 3.3×3.3 | 3.3 × 3.3 |
| node | E | 51 | 37 | 22 | 22 | 7.4 | 14.7 | 22 | 14.7 | 7.4 |
| | $ | 6.66 | 9.46 | 8.06 | 8.06 | 8.06 | 8.06 | 8.06 | 8.06 | 8.06 |

Any appropriate optimization engine may be used to perform the optimization of block 208. Using the weighted sum of communication energy consumption and temperature as an exemplary objective function for the optimization, weighting coefficients of α=0.25 and β=0.75 may be used for the communication energy consumption term η_{C} and the temperature term nr respectively. Using these parameters, an optimized chiplet layout may provide a reduction in communication energy of about 32% relative to a naïve manual placement. Temperature may be reduced by 22%.

Changing the weighting parameters changes the outputs produced by the optimization. For example, increasing a in this example tends to increase the distance between chiplets 104. Some chiplets may be positioned closer to one another than manual placement would arrange them, while chiplets having a greater energy consumption may be placed farther way from other chiplets to distribute heat generation.

Adding a cost term to the optimization, with a respective weighting coefficient γ, lets the optimization make further determinations of which technology node implementation to use for a given chiplet. As γ increases, the cost of the semiconductor device 100 decreases, but communication energy consumption and temperature may increase significantly due to the use of chiplets 104 having larger feature sizes—for example with more chiplets that use a 12 nm technology node instead of a 7 nm technology node.

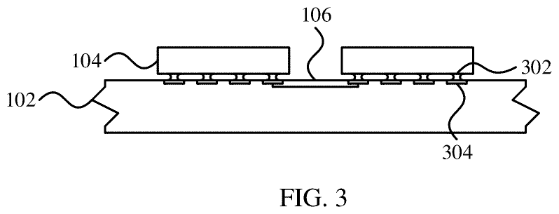

Referring now to FIG. 3, an exemplary cut-away view of a semiconductor device 100 is shown. A pair of chiplets 104 are mounted on the base substrate 102. The base substrate 102 includes conductive pads 304 which make electrical connection to interconnects 106. The interconnects 106 provide signal paths between chiplets 104. The chiplets 104 may be connected to the conductive pads 304 by solder 302, which may be applied to the base substrate 102 as solder balls and which may be heated to reflow the solder when in contact with the chiplets 104.

The base substrate 102 may be, for example, a printed circuit board. The interconnects 106 and the pads 304 may printed on the base substrate 102 using any appropriate mechanism, for example by applying a layer of conductive material to a dielectric base, patterning the conductive material according to the optimized chiplet layout, and etching away any unneeded conductive material. In some embodiments the base substrate 102 may include conductive vias that penetrate from one side of the base substrate 102 to the other, so that chiplets 104 may be mounted on both sides of the base substrate 102. In embodiments with a multi-sided base substrate 102, the optimization of block 208 may include a further decision variable that indicates which side of the base substrate 102 a given chiplet 104 will be mounted on.

The chiplets 104 may be manufactured by any appropriate process or processes. For example, the chiplets 104 may include any appropriate circuitry, including passive components like capacitors, inductors, or resistors, and active components like transistors. These passive and active components may be formed by a series of steps that may include depositing material, patterning material, and etching material.

The patterning process may define the technology node of a chiplet 104. For example, a given patterning process may include photolithography that is based on light of a given wavelength. The wavelength used may define a minimum feature size that can be readily created by a given photolithographic process, as the light is used to cure a photoresist before a subsequent etching process. Chiplets 104 that are formed using a smaller technology node (e.g., 7 nm) may be smaller and have lower internal power losses than a chiplet having an equivalent function and a larger technology node (e.g., 12 nm), but the more advanced processing of the smaller technology node may come with a correspondingly higher cost.

It is to be understood that aspects of the present invention will be described in terms of a given illustrative architecture; however, other architectures, structures, substrate materials and process features and steps can be varied within the scope of aspects of the present invention. It will also be understood that when an element such as a layer, region or substrate is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

The present embodiments can include a design for an integrated circuit chip, which can be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer can transmit the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

Methods as described herein can be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It should also be understood that material compounds will be described in terms of listed elements, e.g., SiGe. These compounds include different proportions of the elements within the compound, e.g., SiGe includes SiₓGe₁₋ₓ where x is less than or equal to 1, etc. In addition, other elements can be included in the compound and still function in accordance with the present principles. The compounds with additional elements will be referred to herein as alloys.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as chiplet layout optimization 419. In addition to block 419, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 200, as identified above), peripheral

device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

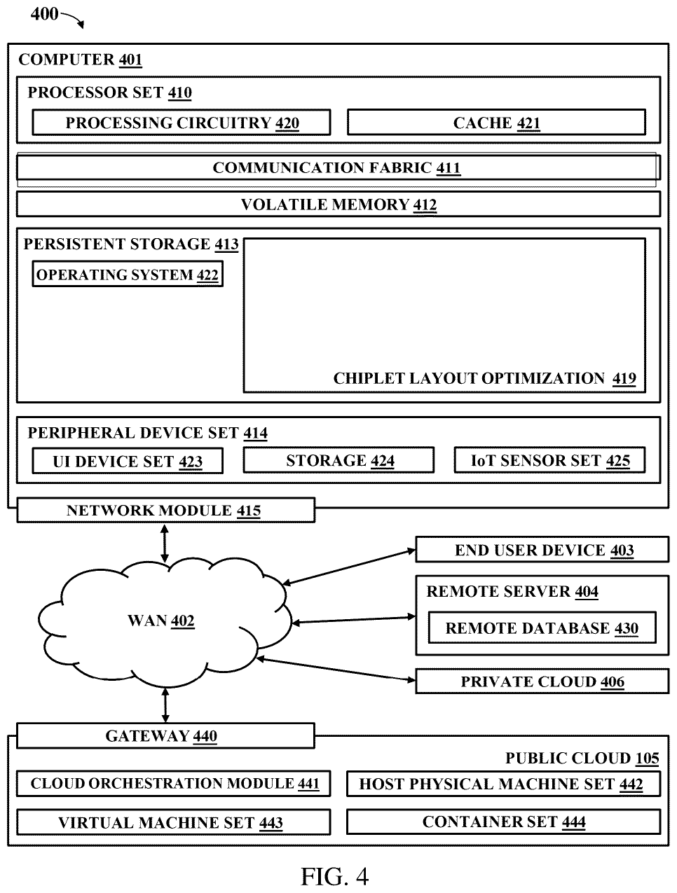

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 200 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

Having described preferred embodiments of chiplet design optimization (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented layout method, comprising:
determining an inter-chiplet communication model for a plurality of chiplets of a semiconductor device design;
optimizing a layout of the plurality of chiplets using an objective function that is a weighted combination of a plurality of different objectives; and
fabricating a semiconductor device in accordance with the layout of the plurality of chiplets by mounting the plurality of chiplets to a base substrate.

2. The method of claim 1, wherein determining the inter-chiplet communication model includes identifying properties of the plurality of chiplets.

3. The method of claim 2, wherein identifying properties of the plurality of chiplets includes accessing previously measured properties of chiplets from a database.

4. The method of claim 2, wherein identifying properties of the plurality of chiplets includes properties specified by a designer of a chiplet.

5. The method of claim 1, wherein the plurality of different objectives are selected from the group consisting of communication energy consumption, temperature, and cost.

6. The method of claim 5, wherein the objective function includes communication energy consumption, calculated as:
$${η}_{C} = {\sum }_{i = 1}^{N} {\sum }_{j = i}^{N} d ( i , j ) C ( i , j ) {E}_{bit}$$
where N is a number of the plurality of chiplets, d(i, j) is a Manhattan distance between chiplets i and j, C(i, j) is a volume of communications between chiplets i and j, and E_{bit} is energy consumption per unit distance to transmit a predetermined amount of data.

7. The method of claim 5, wherein the objective function includes temperature, calculated as:
$${η}_{T} = {\sum }_{i = 1}^{N} {\sum }_{j = 1}^{N} \frac{{n}^{12 n m} ( i ) {P}^{12 n m} ( i ) + ( 1 - {n}^{12 n m} ( i ) ) {P}^{7 n m} ( i )}{d ( i , j )}$$
where N is a number of the plurality of chiplets, n^{12 nm}(i) indicates a technology node of a chiplet i, P^{12 nm}(i) indicates power consumption of the chiplet i at a first technology node, P^{7 nm}(i) indicates power consumption of the chiplet i at a second technology node, and d(i, j) is a Manhattan distance between chiplets i and j.

8. The method of claim 5, wherein the objective function includes cost, calculated as:
$${η}_{E} ( i ) = {\sum }_{i}^{N} {n}^{12 n m} ( i ) {e}^{12 n m} ( i ) + ( 1 - {n}^{12 n m} ( i ) ) {e}^{7 n m} ( i )$$
where N is a number of the plurality of chiplets, n^{12 nm}(i) indicates a technology node of a chiplet I, e^{12 nm}(i) indicates a cost of chiplet i at a first technology node, and e^{7 nm}(i) indicates a cost of chiplet i at a second technology node.

9. The method of claim 1, wherein the layout includes a plurality of optimized parameters and wherein optimizing the layout is further performed with at least one constraint on at least one of the plurality of optimized parameters.

10. The method of claim 9, wherein the constraint is selected from the group consisting of a boundary constraint, a minimum distance constraint, a maximum temperature constraint, and a maximum energy consumption constraint.

11. A computer program product for layout, the computer program product comprising:
a set of one or more computer readable storage media; and
program instructions, collectively stored in the set of one or more storage media, for causing a processor set to perform the following computer operations:
determine an inter-chiplet communication model for a plurality of chiplets of a semiconductor device design;
optimize a layout of the plurality of chiplets using an objective function that is a weighted combination of a plurality of different objectives; and
fabricate a semiconductor device in accordance with the layout of the plurality of chiplets by mounting the plurality of chiplets to a base substrate.

12. The computer program product of claim 11, wherein determining the inter-chiplet communication model includes identifying properties of the plurality of chiplets.

13. The computer program product of claim 12, wherein identifying properties of the plurality of chiplets includes accessing previously measured properties of chiplets from a database.

14. The computer program product of claim 12, wherein identifying properties of the plurality of chiplets includes properties specified by a designer of a chiplet.

15. The computer program product of claim 11, wherein the plurality of different objectives are selected from the group consisting of communication energy consumption, temperature, and cost.

16. The computer program product of claim 15, wherein the objective function includes communication energy consumption, calculated as:
$${η}_{C} = {\sum }_{i = 1}^{N} {\sum }_{j = i}^{N} d ( i , j ) C ( i , j ) {E}_{bit}$$
where N is a number of the plurality of chiplets, d(i, j) is a Manhattan distance between chiplets i and j, C(i, j) is a volume of communications between chiplets i and j, and E_{bit} is energy consumption per unit distance to transmit a predetermined amount of data.

17. The computer program product of claim 15, wherein the objective function includes temperature, calculated as:
$${η}_{T} = {\sum }_{i = 1}^{N} {\sum }_{j = 1}^{N} \frac{{n}^{12 n m} ( i ) {P}^{12 n m} ( i ) + ( 1 - {n}^{12 n m} ( i ) ) {P}^{7 n m} ( i )}{d ( i , j )}$$
where N is a number of the plurality of chiplets, n^{12 nm}(i) indicates a technology node of a chiplet i, P^{12 nm}(i) indicates power consumption of the chiplet i at a first technology node, P^{7 nm}(i) indicates power consumption of the chiplet i at a second technology node, and d(i, j) is a Manhattan distance between chiplets i and j.

18. The computer program product of claim 15, wherein the objective function includes cost, calculated as:
$${η}_{E} ( i ) = {\sum }_{i}^{N} {n}^{12 n m} ( i ) {e}^{12 n m} ( i ) + ( 1 - {n}^{12 n m} ( i ) ) {e}^{7 n m} ( i )$$
where N is a number of the plurality of chiplets, n^{12 nm}(i) indicates a technology node of a chiplet I, e^{12 nm}(i) indicates a cost of chiplet i at a first technology node, and e^{7 nm}(i) indicates a cost of chiplet i at a second technology node.

19. The computer program product of claim 11, wherein the layout includes a plurality of optimized parameters and wherein optimizing the layout is further performed with at least one constraint on at least one of the plurality of optimized parameters.

20. A computer system for layout, the computer system comprising:
a processor set;
a set of one or more computer readable storage media; and
program instructions, collectively stored in the set of one or more storage media, for causing a processor set to perform the following computer operations:
determine an inter-chiplet communication model for a plurality of chiplets of a semiconductor device design;
optimize a layout of the plurality of chiplets using an objective function that is a weighted combination of a plurality of different objectives; and
fabricate a semiconductor device in accordance with the layout of the plurality of chiplets by mounting the plurality of chiplets to a base substrate.
